(19) United States
(12) Patent Application Publication
(10) Pub. No.: US 2005/0235084 A1
(43) Pub. Date: Oct. 20, 2005

(54) Bus system and access control method

(75) Inventor: Kyoichi Nariai, Kanagawa (JP)

Correspondence Address: MCGINN & GIBB, PLLC, 8321 OLD COURTHOUSE ROAD, SUITE 200, VIENNA, VA, 22182-3817, US

(73) Assignee: NEC Electronics Corporation, Kawasaki (JP)

(21) Appl. No.: 11/069,947

(22) Filed: Mar. 3, 2005

(30) Foreign Application Priority Data
Apr. 3, 2004 (JP) 2004-060172

(51) Int. Cl. G06F 13/00

(52) U.S. Cl. 710/110; 710/316

(57) ABSTRACT

The bus system includes a plurality of masters, a plurality of slaves, and a multilayer switch. The bus system further includes an access control register to which access control information is set by a predetermined secure master. The multilayer switch includes switch master portions and switch slave portions. When a master accesses a slave, a switch master portion corresponding to a master different from the secure master determines whether the access is made to an access control area based on address information of an access destination and access control information stored in the access control register. If the switch master portion determines that the access is made to the access control area, it inhibits the access.

### BACKGROUND OF THE INVENTION

1. Field of the Invention

The present invention relates to a bus system connected to a plurality of masters and slaves, and an access control method.

2. Description of Related Art

In a bus system connected to a plurality of masters and slaves, it may be necessary in some cases to prevent a master different from a specific master from accessing a specific slave. For example, when confidential information or key information is stored in a given memory, the access to this memory from a processing unit such as CPU is permitted, but the access from other masters should be inhibited.

A technique for the access control is disclosed in Japanese Unexamined Patent Application Publication No. 05-257516. This technique places a master identification signal generation circuit for each of a plurality of masters, and further places a master identification circuit that identifies a master identification signal. A decoder generates a given control signal based on identification results, and informs the master that has made an access whether the access is valid or not. The technique controls input/output (I/O) with the generated control signal and informs the master that has made an access whether the access is valid or not, thereby preventing unauthorized access to a data I/O circuit.

According to the above technique, the data I/O circuit includes the master identification circuit and the decoder, and the decoder receives an access authorization signal output from the master identification circuit to determine whether the access should be permitted or not based on this signal. This configuration has the following disadvantages. Since the area where the access is controlled is determined by hardware, the area which can be controlled in the system is fixed to the data I/O circuit part having the master identification circuit. Further, it is impossible to control the access to only a part of the I/O of the data I/O circuit. Furthermore, since access protection is performed in the data I/O part, when a master accesses a protected part, transaction occurs in the system bus. Thus, if a master continuously accesses the data I/O circuit under access control by accident or on purpose, the performance of the system bus significantly decreases due to the transaction.

Recent mobile phones have become multifunctional, having not only telephone functions but also internet connection functions, camera functions and so on. Further, in order to realize downsizing, weight saving, and reduction in power consumption, System on Chip (SoC) technology which incorporates multiple functions on one chip has been developed.

Such mobile phones require high speed, simultaneous processing. Thus, a multilayer switch which allows simultaneous access to a plurality of slaves has been proposed.

Use of the multilayer switch permits to carry out a process of writing image data from a camera into a given memory region and a process of reading the image data stored in the memory and displaying it on a screen at the same time. In such a multilayer system as well, the same problems as in the above conventional technique can occur.

As described in the foregoing, the present invention has recognized that conventional bus systems have a problem that continuous access to a slave under access control causes significant deterioration of bus performance.

### SUMMARY OF THE INVENTION

According to one aspect of the present invention, there is provided a bus system including a plurality of masters; a plurality of slaves; a multilayer switch disposed between the masters and the slaves, simultaneously processing commands from the plurality of masters, and having switch master portions corresponding to the masters and switch slave portions corresponding to the slaves; and an access control register to which access control information is set by a predetermined secure master. In this bus system, upon occurrence of an access from a master to a slave, a switch master portion corresponding to a master different from the secure master determines whether the access is made to an access control area based on address information of an access destination and access control information stored in the access control register, and if determining that the access is made to the access control area, inhibits the access. Since the switch master portion performs access control with reference to the access control register, even if a specific master repeatedly accesses a slave under access control, access to the switch slave portion and the slave does not occur, thereby preventing decrease in bus access performance of the master other than the specific master connected to the multilayer switch.

According to another aspect of the present invention, there is provided a bus system including a plurality of masters; a plurality of slaves; a system bus to which the masters and the slaves are connected; an arbiter setting authorization to use the system bus; an access control register to which access control information is set by a predetermined secure master; and a switch disposed between a master different from the secure master and the system bus. In this bus system, upon occurrence of an access from a master different from the secure master to the slave, the arbiter determines whether the access is made to an access control area based on address information of an access destination and access control information stored in the access control register, and if determining that the access is made to the access control area, inhibits the access with the switch. Since the arbiter performs access control with reference to the access control register using the switch between the connection point of the system bus and the master, even if a specific master repeatedly accesses a slave under access control, access to the system bus does not occur, thereby preventing decrease in system bus performance.

According to yet another aspect of the present invention, there is provided an access control method in a bus system including a plurality of masters, a plurality of slaves, and a multilayer switch disposed between the masters and the slaves and simultaneously processing commands from the plurality of masters. The method includes setting by a predetermined secure master access control information to an access control register; upon occurrence of an access from a master different from the secure master to a slave, comparing address information of an access destination with access control information set to the access control register and determining whether the access is made to an access control area; and upon determination that the access is made to the access control area, inhibiting the access by a switch master portion in the multilayer switch. Since the switch master portion performs access control with reference to the access control register, even if a specific master repeatedly accesses a slave under access control, access to the switch slave portion and the slave does not occur, thereby preventing decrease in bus access performance of the master other than the specific master connected to the multilayer switch.

According to still another aspect of the present invention, there is provided an access control method in a bus system including a plurality of masters, a plurality of slaves, a system bus to which the masters and the slaves are connected, and an arbiter setting authorization to use the system bus. The method includes setting by a predetermined secure master access control information to an access control register; upon occurrence of an access from a master different from the secure master to a slave, determining by the arbiter whether the access is made to an access control area based on address information of an access destination and access control information set to the access control register, and upon determination by the arbiter that the access is made to the access control area, inhibiting the access by a switch disposed between the masters and the system bus. Since the arbiter performs access control with reference to the access control register using the switch between the connection point of the system bus and the master, even if a specific master repeatedly accesses a slave under access control, access to the system bus does not occur, thereby preventing decrease in system bus performance.

The present invention provides a bus system and an access control method allowing optimal access control.

### BRIEF DESCRIPTION OF THE DRAWINGS

The above and other objects, advantages and features of the present invention will be more apparent from the following description taken in conjunction with the accompanying drawings, in which:

FIG. 1 is a block diagram of a bus system of the present invention;

FIG. 2 is a diagram showing a layout example of a chip using the bus system of the present invention and a circuit configuration example of elements related to power supply; and

FIG. 3 is a block diagram of another bus system of the present invention.

### DESCRIPTION OF THE PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposed.

### First Embodiment

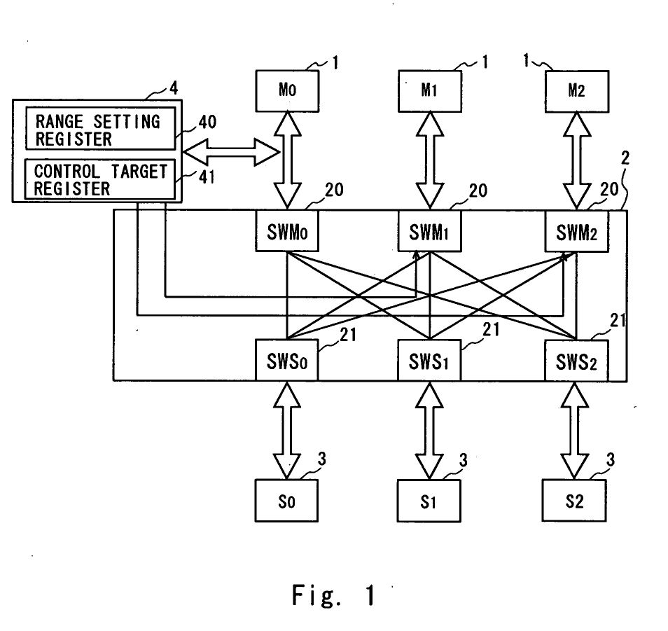

FIG. 1 shows a block diagram of a bus system of a first embodiment of the present invention. The bus system in this embodiment is a multilayer system. The multilayer system basically includes a plurality of masters 1 (M0, M1, M2), a plurality of slaves 3 (S0, S1, S2), and a multilayer switch 2 disposed between the masters 1 and the slaves 3. In this embodiment, the multilayer system further includes an access control register 4.

The master 1 is a module that controls the system, such as Central Processor Unit (CPU), Digital Signal Processor (DSP), image rotating device, camera image processing circuit, Liquid Crystal Display (LCD) controller, and so on. In this example, the M0 is a processing circuit such as CPU and DSP that always operate. The M1 and M2 are modules that operate as needed according to instructions from the M0.

The multilayer switch 2 allows simultaneous processing of commands from a plurality of masters. The multilayer switch 2 is an interconnection bus system that allows use of a parallel access path between a plurality of masters and slaves in the system. The bus system is realized by use of a more complex interconnection matrix and provides advantages such as increase in architecture options and in the entire bus bandwidth. The multilayer switch 2 is offered by ARM Ltd. as Advanced High-performance Bus (AHB), AHB-Lite®, for example.

The slave 3 is a module that is controlled by the master 1. For example, the slave 3 includes a memory, a register, a timer, a serial interface circuit, and so on.

The configuration of the multilayer switch 2 is described in detail below. The multilayer switch 2 has switch master portions 20 (SWM0, SWM1, SWM2) connected to each of the masters 1 (M0, M1, M2), and switch slave portions 21 (SWS0, SWS1, SWS2) connected to each of the slaves 3.

The switch master portion 20 has the function that determines which slave 3 is to be connected in response to the access from the master 1 based on address information specifying an access destination and sends an access request to the switch slave portion 21 corresponding to the slave 3 to be connected. Further, the switch master portion 20 in this embodiment has an address comparator circuit, though not shown. The address comparator circuit compares address information included in the access control information from the access control register 4 with address information included in the access from the master 1, and, if they match, controls the access to the slave specified by the address information.

The key function of the switch slave portion 21 is to arbitrate the access signals from each switch master portion 20, select one access and make a connection to the selected slave 3.

The access control register 4 includes a range setting register 40 and a control target register 41 to store access control information. The access control information includes control range information and control target information. The control range information specifies an access control area in the slave 3, and is stored in the range setting register 40. The control target information specifies for which master 1 the access control should be activated, and is stored in the control target register 41.

Information can be set to the range setting register 40 and the control target register 41 only by the M0, which is a secure master. Other masters such as the M1 and M2 cannot set the information. It is preferred to create a hardware configuration so as to allow the only M0, the secure master, to set information to the range setting register 40 and the control target register 41. Specifically, the secure master M0 is connected to a local bus, and the area where the master different from the M0 cannot access the address comparator circuit is created by default.

The range setting register 40 and the control target register 41 are connected to the SWM1 and SWM2 by signal lines. Specifically, the address comparator circuits included in the SWM1 and SWM2 are connected to the range setting register 40 and the control target register 41 by signal lines. Thus, detecting the voltage of these signal lines allows recognizing the address control information stored in the range setting register 40 and the control target register 41.

Now, the processing operation in the multilayer system of the first embodiment of the invention is described below. In this example, S2 is a memory that stores confidential information in the addresses 8000 to FFFF. Access is controlled to these addresses from the masters 1 other than the M0, which are M1 and M2 for example. The case where the M1 subject to access control tries to access the information stored in the address 8000, which is within the area of the addresses 8000 to FFFF of the S2, is described hereinafter.

The M1 outputs an address signal (“8000”) of an access destination (the S2 in this case) and a control signal such as a read/write signal to the SWM1, which is the switch master portion 20 of the multilayer switch 2.

The SWM1 determines which slave 3 is to be accessed based on the address signal from the M1. Further, in the SWM1, the address comparator circuit compares address information included in the address signal from the M1 with address information included in the control range information set to the range setting register 40. Since the area of the addresses 8000 to FFFF is set to the range setting register 40 as an access control area in this case, the SWM1 operates with a recognition that the address 8000 where the M1 tries to access is within the control range. Thus, the SWM1 determines that the M1 makes an access to the access control area. In this case, the SWM1 does not transmit transaction to the SWS2 of the multilayer switch 2, but sends an error response to the M1 to inhibit the access to the access control area.

As described above, the switch master portion 20 performs access control with reference to the access control register 4 in this embodiment. Thus, even if a specific master repeatedly accesses the slave under access control, the access to the switch slave portion 21 and the slave 3 does not occur, thereby preventing decrease in the bus access performance of the master different from the specific master connected to the multilayer switch 2.

Further, in this embodiment, the access control area may be set to a given area of the system memory map. This embodiment also allows setting which master is inhibited to access the set area.

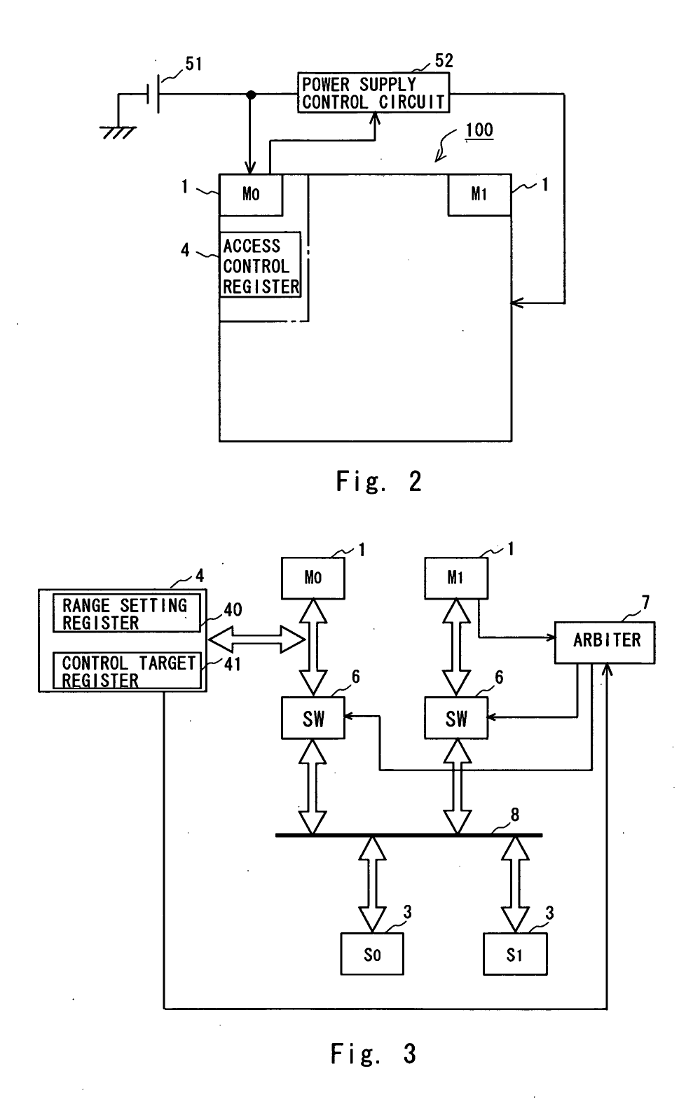

It is preferred to perform a different power supply control from other circuits or the like for the M0, which is the secure master in this embodiment, and the access control register 4. FIG. 2 shows a layout example of a chip 100 and a circuit configuration example of elements related to power supply. As shown in FIG. 2, power is constantly supplied to the M0 and the access control register 4 from a power supply 51. On the other hand, power is supplied to the other circuits including the M1 via a power supply control circuit 52. The power supply control circuit 52 operates in accordance with the control by the M0, and it stops power supply to each master 1, slave 3, and so on when not needed. This achieves power saving in the chip 100.

Even when the other circuits such as the M1 are turned off by the power supply control circuit 52, the access control register 4 is on, and thus the data set to the access control register 4 is not erased.

### Second Embodiment

A second embodiment of the present invention uses a normal bus, not a multilayer system. FIG. 3 shows the configuration of a bus system according to the second embodiment. A switch 6 is placed between the connection point of a system bus 8 and a master 1. The address of an access destination of M1 is input to an arbiter 7. Access control information stored in the range setting register 40 and the control target register 41 is also input to the arbiter 7. The access control information can be set to the access control register 4 only by the M0, which is a secure master. The arbiter 7 has a function to set authorization to use the system bus 8 by the master 1.

The processing operation in the bus system of the second embodiment is described below. The M1 outputs the address signal of an access destination to the arbiter 7. The arbiter 7 compares address information included in this address signal with address information included in access control information stored in the access control register 4, and outputs a comparison result. In this example, the arbiter 7 determines that the M1 makes an access to the set access control area. In this case, the arbiter 7 requests the switch 6 between the M1 and the connection point of the system bus 8 to prevent the access from the M1 to the system bus 8. In response to this request, the switch 6 sends an error response signal indicating that the access is inhibited to the master. This prevents the M1 from accessing the access control area.

As described above, the arbiter 7 performs access control with reference to the access control register 4 using the switch 6 placed between the connection point of the system bus 8 and the master 1 in this embodiment. Thus, even if a specific master repeatedly accesses the slave under the access control, the access to the system bus 8 does not occur, thereby preventing decrease in the system bus performance.

Further, in this embodiment, the access control area may be set to a given area of the system memory map. This embodiment also allows setting which master is inhibited to access the set area.

It is apparent that the present invention is not limited to the above embodiment that may be modified and changed without departing from the scope and spirit of the invention.

1. A bus system comprising:
a plurality of masters;
a plurality of slaves;
a multilayer switch disposed between the masters and the slaves, simultaneously processing commands from the plurality of masters, and comprising switch master portions corresponding to the masters and switch slave portions corresponding to the slaves; and
an access control register to which access control information is set by a predetermined secure master;
wherein, upon occurrence of an access from a master to a slave, a switch master portion corresponding to a master different from the secure master determines whether the access is made to an access control area based on address information of an access destination and access control information stored in the access control register, and if determining that the access is made to the access control area, inhibits the access.

2. The bus system of claim 1, wherein power is constantly supplied to the secure master and the access control register.

3. The bus system of claim 2, wherein power supply to the master different from the secure master and/or the slave is controlled by the secure master.

4. The bus system of claim 1, wherein the access control register comprises a range setting register storing range setting information setting an access control area, and a control target register storing control target information specifying a master to be controlled.

5. A bus system comprising:
a plurality of masters;
a plurality of slaves;
a system bus to which the masters and the slaves are connected;
an arbiter setting authorization to use the system bus;
an access control register to which access control information is set by a predetermined secure master; and
a switch disposed between a master different from the secure master and the system bus,
wherein, upon occurrence of an access from a master different from the secure master to the slave, the arbiter determines whether the access is made to an access control area based on address information of an access destination and access control information stored in the access control register, and if determining that the access is made to the access control area, inhibits the access with the switch.

6. The bus system of claim 5, wherein power is constantly supplied to the secure master and the access control register.

7. The bus system of claim 6, wherein power supply to the master different from the secure master and/or the slave is controlled by the secure master.

8. The bus system of claim 5, wherein the access control register comprises a range setting register storing range setting information setting an access control area, and a control target register storing control target information specifying a master to be controlled.

9. An access control method in a bus system including a plurality of masters, a plurality of slaves, and a multilayer switch disposed between the masters and the slaves and simultaneously processing commands from the plurality of masters, the method comprising:
setting by a predetermined secure master access control information to an access control register;
upon occurrence of an access from a master different from the secure master to a slave, comparing address information of an access destination with access control information set to the access control register and determining whether the access is made to an access control area; and
upon determination that the access is made to the access control area, inhibiting the access by a switch master portion in the multilayer switch.

10. The access control method of claim 9, wherein power is constantly supplied to the secure master and the access control register.

11. The access control method of claim 10, wherein power supply to the master different from the secure master and/or the slave is controlled by the secure master.

12. The access control method of claim 9, wherein the access control register comprises a range setting register storing range setting information setting an access control area, and a control target register storing control target information specifying a master to be controlled.

13. An access control method in a bus system including a plurality of masters, a plurality of slaves, a system bus to which the masters and the slaves are connected, and an arbiter setting authorization to use the system bus, the method comprising:
setting by a predetermined secure master access control information to an access control register;
upon occurrence of an access from a master different from the secure master to a slave, determining by the arbiter whether the access is made to an access control area based on address information of an access destination and access control information set to the access control register, and
upon determination by the arbiter that the access is made to the access control area, inhibiting the access by a switch disposed between the masters and the system bus.

14. The access control method of claim 13, wherein power is constantly supplied to the secure master and the access control register.

15. The access control method of claim 14, wherein power supply to the master different from the secure master and/or the slave is controlled by the secure master.

16. The access control method of claim 13, wherein the access control register comprises a range setting register storing range setting information setting an access control area, and a control target register storing control target information specifying a master to be controlled.
